(19) United States
(12) Patent Application Publication
(10) Pub. No.: US 2026/0264436 A1
(43) Pub. Date: Sep. 10, 2026

(54) PRINTER

(71) Applicant: Kazuaki Sugimoto, Numazu Shizuoka (JP)

(72) Inventor: Kazuaki Sugimoto, Numazu Shizuoka (JP)

(73) Assignee: ETRIA Co., Ltd., Kanagawa (JP)

(21) Appl. No.: 19/447,175

(22) Filed: Jan. 13, 2026

(30) Foreign Application Priority Data
Mar. 10, 2025 (JP) 2025-037741

(51) Int. Cl. B41J 33/36; B41J 2/325; B41J 11/04; B41J 11/14; B41J 15/04; B41J 29/387; B41J 29/393; B41J 35/38

(52) U.S. Cl. CPC B41J 33/36; B41J 2/325; B41J 11/04; B41J 11/14; B41J 15/04; B41J 29/387; B41J 29/393; B41J 35/38

(57) ABSTRACT

A printer according to an embodiment includes: a print head provided adjacent to a transport path; a transport unit that conveys a print medium along the transport path at a first speed; a supply unit driven by a drive motor and configured to supply an ink ribbon to the region between the print medium and the print head along the transport direction of the print medium at a second speed; a control unit that controls the voltage applied to the drive motor such that the second speed becomes equal to the first speed; and a drive cut-off unit that interrupts a drive transmission path of the drive motor when the second speed exceeds the first speed by a predetermined threshold.

### CROSS-REFERENCE TO RELATED APPLICATIONS

This application is based upon and claims the benefit of priority from Japanese Patent Application No.2025-037741, filed Mar. 10, 2025, the entire contents of which are incorporated herein by reference.

### FIELD

Embodiments described herein relate generally to printers that print an image by transferring ink from an ink ribbon to a print medium.

### BACKGROUND

Conventionally, there exists a printer that forms an image on a print medium by transferring ink from an ink ribbon via a thermal head. This printer conveys an elongated print medium, such as a label sheet, and feeds the ink ribbon over the print medium.

In the printer that uses the ink ribbon, the ink ribbon must be fed at the same speed as the print medium. The printer is thus designed so that the used ink ribbon, after passing through the thermal head, is rewound with a predetermined tension. As the diameter of the ribbon roll that takes up the used ink ribbon gradually increases, the torque applied to the take-up shaft must be adjusted in accordance with the roll diameter in order to consistently maintain the predetermined tension.

In the conventional printer described above, for example, the diameter of the ribbon roll around which the used ink ribbon has been rewound is detected, and the voltage of the DC motor that rotates the take-up shaft is controlled in accordance with the roll diameter.

In general, a DC motor that allows torque control takes a longer time to accelerate from rest to a constant speed than a stepping motor. Therefore, control is performed such that the current is increased during motor startup to shorten the acceleration time, and decreased when the motor reaches the constant speed.

If the current of the DC motor is controlled as above, the rotational speed of the DC motor becomes unstable during the transition from acceleration to a constant speed. In this case, if slack is generated in the ink ribbon between the take-up shaft and the thermal head, the ink ribbon becomes difficult to separate from the print medium. Therefore, the current of the DC motor is typically set relatively high during startup to prevent slack in the ink ribbon.

However, if the tension of the ink ribbon wound by the take-up shaft is set excessively high, friction between the ink ribbon and the print medium may cause the ink ribbon to pull the print medium. As a result, the transport speed of the print medium temporarily increases, causing the printed image to be elongated in the transport direction.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an external perspective view of a printer according to an embodiment.

FIG. 2 is a schematic view showing the internal structure of the printer of FIG. 1.

FIG. 3 is a schematic diagram showing a ribbon roll mounting portion of the printer of FIG. 1.

FIG. 4 is a schematic perspective view showing the drive transmission mechanism of the mounting portion of FIG. 3.

FIG. 5 is a schematic diagram showing the major portion of the drive transmission mechanism of FIG. 4.

FIG. 6 is a block diagram of a control system that controls the operation of the printer of FIG. 1.

FIG. 7 is a diagram showing the characteristics of the motors used in the printer of FIG. 1.

### DETAILED DESCRIPTION

A printer according to the present embodiment includes: a print head provided adjacent to a transport path; a transport unit that conveys a print medium along the transport path at a first speed; a supply unit driven by a drive motor and configured to supply an ink ribbon between the print medium and the print head at a second speed along the transport direction of the print medium; a control unit that controls the voltage applied to the drive motor such that the second speed becomes equal to the first speed; and a drive cut-off unit that interrupts a drive transmission path of the drive motor when the second speed exceeds the first speed by a predetermined threshold.

Embodiments will now be described with reference to the drawings.

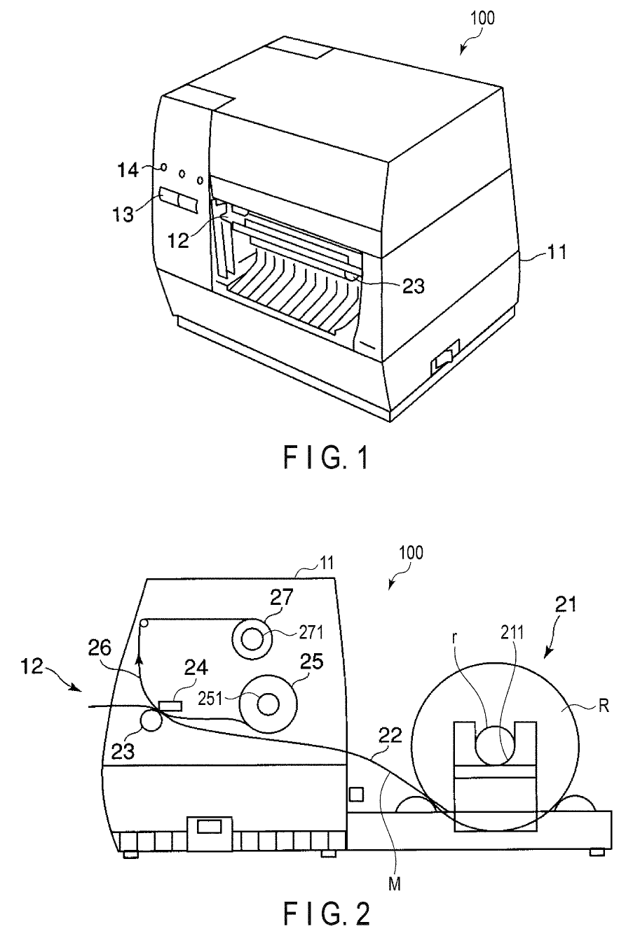

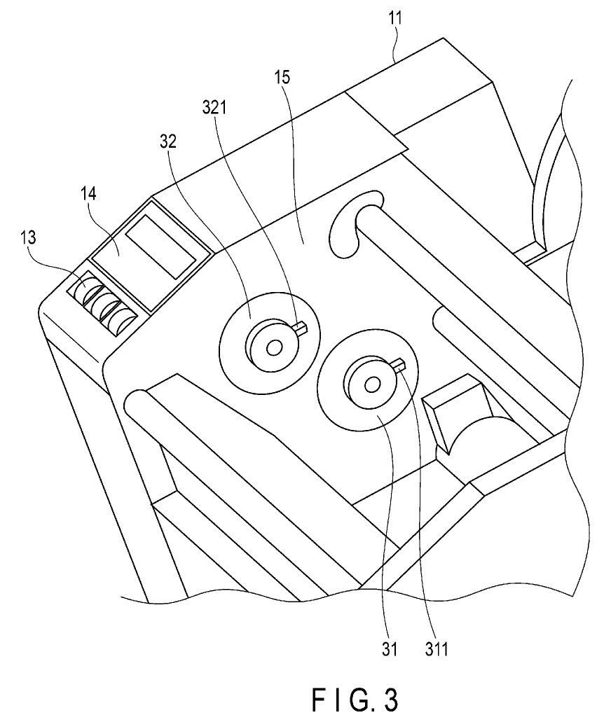

As shown in FIG. 1, the printer 100 of the present embodiment includes a housing 11 having a shape of a substantially rectangular box. As shown in FIG. 2, a supply unit 21 that supplies a print medium M from a roll R is provided on the rear side of the housing 11. Illustration of the supply unit 21 is omitted in FIG. 1. The supply unit 21 has U-shaped holding grooves 211 that rotatably receive both ends of the shaft r of the roll R.

The print medium M is, for example, an elongated, strip-shaped label sheet with a plurality of labels arranged in one direction. The roll R is, for example, a label sheet M that is wound around the shaft r, with the printed side of the labels facing inward. The print medium M is not limited to the label sheet. When the print medium M is pulled out from the roll R, the roll R rotates clockwise in FIG. 2.

The front side of the housing 11 is provided with a discharge port 12 from which the print medium M with an image printed thereon is discharged. The front side of the housing 11 is also provided with an operation switch 13 and a plurality of LED light emitters 14. The housing 11 includes a cover that can be opened and closed and enables access to the interior.

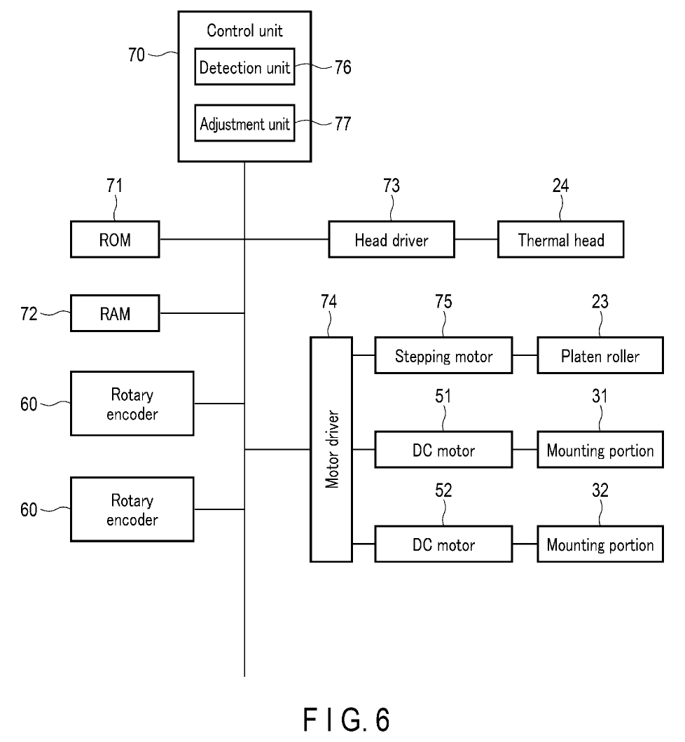

The printer 100 defines a transport path 22 along which the print medium M is conveyed from the supply unit 21 toward the discharge port 12. A platen roller 23 is located near the discharge port 12 and below the transport path 22. The platen roller 23 is driven by a stepping motor 75 (FIG. 6). The platen roller 23 and the stepping motor 75 are an example of a transport unit that conveys the print medium M along the transport path 22 at a constant speed (first speed).

A thermal head 24 is located opposite the platen roller 23 across the transport path 22. The thermal head 24 is located adjacent to and above the transport path 22. The thermal head 24 presses the print medium M against the platen roller 23. The thermal head 24 is an example of a print head, and is also a component of the transport unit that applies the transport force of the platen roller 23 to the print medium M.

When the platen roller 23 is rotated, a transport force is applied from the platen roller 23 to the print medium M, which is pressed against the platen roller 23 by the thermal head 24. This transport force causes the print medium M to be pulled out of the roll R and discharged to the outside of the housing 11 from the discharge port 12.

The printer 100 is provided with a feed-side ribbon roll 25 and a take-up-side ribbon roll 27 above the transport path 22. The feed-side ribbon roll 25 comprises an unused, elongated ink ribbon 26 wound around a paper tube 251. The take-up-side ribbon roll 27 comprises a used ink ribbon 26 that has been fed from the ribbon roll 25. Ink is transferred from this ribbon 26 to the print medium M by the thermal head 24, and the used ribbon is wound around a paper tube 271. The ribbon roll 27 is located above the ribbon roll 25.

A DC motor 51 (FIG. 6) applies torque to the feed-side ribbon roll 25 in the direction opposite to the feeding direction of the ink ribbon 26. A DC motor 52 (FIG. 6) applies torque to the take-up-side ribbon roll 27 in the direction in which the ink ribbon 26 is wound. By adjusting the drive voltages applied to the DC motors 51 and 52 using an adjustment unit 77 (FIG. 6), the torques applied to the ribbon rolls 25 and 27 can be adjusted, and the ink ribbon 26 can be supplied at the same speed (second speed) as the transport speed of the printing medium M, with a predetermined tension kept applied to the ink ribbon 26. The DC motors 51 and 52 are components of the supply unit that supplies the ink ribbon 26 along the transport path 22.

The ink ribbon 26 fed from the ribbon roll 25 passes between the platen roller 23 and the thermal head 24 in such a manner as to overlap above the print medium M. The ink ribbon 26 is fed in the same direction as the print medium M. By applying torque to the ribbon roll 27 in the direction that winds up the ink ribbon 26 and applying torque to the ribbon roll 25 in the opposite direction, tension can be applied to the ink ribbon 26, and the ink ribbon 26 that has passed the thermal head 24 can be wound up with appropriate tension.

As shown in FIG. 3, the printer 100 includes a mounting portion 31 to which one end of the feed-side ribbon roll 25 is attached, and a mounting portion 32 to which one end of the take-up-side ribbon roll 27 is attached. The housing 11 includes a frame 15 to which the mounting portions 31 and 32 are rotatably mounted. The mounting portion 31 includes a radially extending protrusion 311 that fits into a notch provided in one end of the paper tube 251 of the ribbon roll 25. The mounting portion 32 includes a radially extending protrusion 321 that fits into a notch provided in one end of the paper tube 271 of the ribbon roll 27.

The printer 100 includes support portion on opposite sides of the two mounting portions 31 and 32, as viewed in the width direction of the transport path 22, and the support portion rotatably support and press the other ends of the ribbon rolls 25 and 27 toward one end. The support portion is provided with an elastic member that elastically supports the other ends of the ribbon rolls 25 and 27 in the axial direction. The ribbon rolls 25 and 27 are pressed at one end against the mounting portions 31 and 32, with the other ends thereof pushed by the support portion.

When the ribbon rolls 25 and 27 are mounted to the printer 100, the cover is opened, the ribbon rolls 25 and 27 are inserted into the housing 11, the other ends of the paper tubes 251 and 271 are attached to the support portion, and the support portion is pressed toward one end. Then, the protrusions 311 and 321 of the mounting portions 31 and 32 are fitted into the notches at one end of the paper tubes 251 and 71, respectively, and the ribbon rolls 25 and 27 are pressed at one end against the mounting portions 31 and 32. In this state, the mounting portions 31 and 32 are rotated by the DC motors 51 and 52, thereby rotating the ribbon rolls 25 and 27.

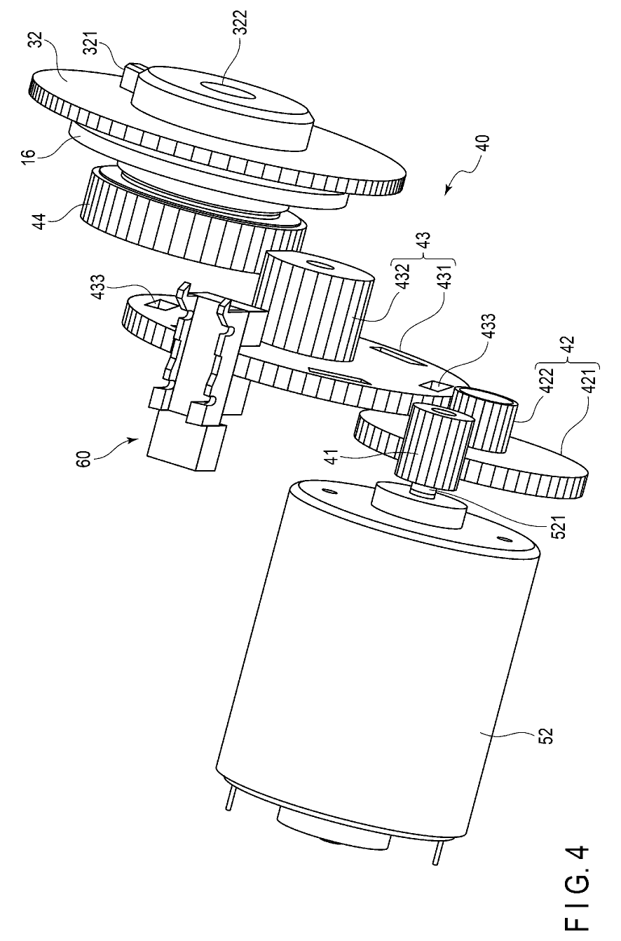

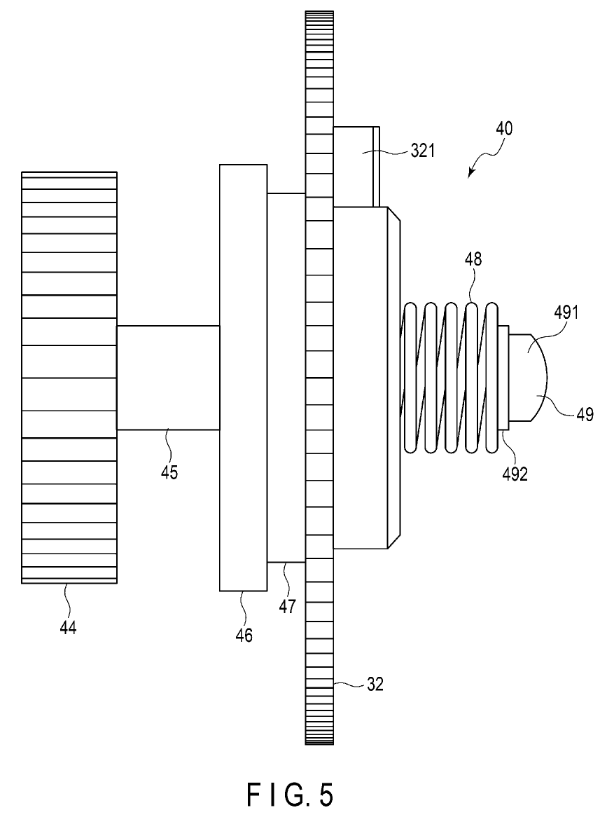

As shown in FIGS. 4 and 5, a drive transmission mechanism 40 is located between the mounting portion 32 for mounting the take-up-side ribbon roll 27, and the DC motor 52. The drive transmission mechanism 40 includes a motor gear 41, a double gear 42, a double gear 43, a drive gear 44, a drive shaft 45, a slip plate 46, a friction plate 47, a compression coil spring 48, and a torque adjustment screw 49. A drive transmission mechanism 40 having an approximately similar structure is located between the mounting portion 31 for mounting the feed-side ribbon roll 25, and the DC motor 51. Accordingly, the take-up-side transmission mechanism 40 will be described as a representative example, and a description of the feed-side drive transmission mechanism will be omitted.

The motor gear 41 is coaxially fixed to the rotating shaft 521 of the DC motor 52. The motor gear 41 meshes with the large-diameter gear 421 of the double gear 42. The double gear 42 includes, as well as the large-diameter gear 421, a small-diameter gear 422, and the large- and small-diameter gears 421 and 422 are integrally formed and coaxial with each other. The double gear 42 has its small diameter gear 422 meshed with the large diameter gear 431 of the double gear 43. The double gear 43 includes, as well as the large-diameter gear 431, a small-diameter gear 432, and the large- and small-diameter gears 431 and 432 are integrally formed and coaxial with each other. The double gear 43 has its small diameter gear 432 meshed with the drive gear 44. The drive gear 44 includes the drive shaft 45 integral and coaxial therewith.

When the DC motor 52 is driven, the motor gear 41 fixed to the rotation shaft 521 rotates, rotating the double gear 42, which has its large diameter gear 421 meshed with the motor gear 41. When the double gear 42 rotates, the double gear 43 having its large-diameter gear 431 meshed with the small-diameter gear 422 of the double gear 42 also rotates. When the double gear 43 rotates, the drive gear 44, which meshes with the small diameter gear 432 of the double gear 43, rotates, causing the drive shaft 45 integrally formed with the drive gear 44 to rotate.

A substantially circular holding member 16 is rotatably mounted on the frame 15 of the printer 100. The holding member 16 rotatably supports the drive shaft 45 of the drive transmission mechanism 40 at its center via a bearing. The holding member 16 is a component that rotates integrally with the mounting portion 32 of the ribbon roll 27.

The drive shaft 45 has the substantially circular slip plate 46 fixed coaxially thereto. The tip of the drive shaft 45 passes through the slip plate 46 and protrudes to the opposite side. The friction plate 47, which is in contact with the slip plate 46, is a substantially annular member through which the drive shaft 45 projecting from the slip plate 46 can be inserted. The friction plate 47 is arranged coaxially with the drive shaft 45, and is rotatable about the drive shaft 45 as well as axially movable relative thereto. The friction plate 47 is attached such that it can rotate integrally with the holding member 16 and the mounting portion 32 and can move axially relative to the holding member 16 and the mounting portion 32.

The compression coil spring 48 is attached to the mounting portion 32 in a compressed state. The compression coil spring 48 is an example of an elastic member that presses the friction plate 47 against the slip plate 46 with its restoring force. The mounting portion 32 includes a recess 322 with a substantially circular cross section that accommodates the compression coil spring 48. The recess 322 is a hole that opens on the side of the ribbon roll 27. The tip of the compression coil spring 48, housed in the recess 322, abuts against the friction plate 47.

The torque adjustment screw 49 integrally includes a flange 492 between its head 491 and shank, and the flange 492 has threads along its outer periphery. The flange 492 abuts against the base end of the compression coil spring 48. The torque adjustment screw 49 can be screwed into the recess 322 by inserting its shank through the compression coil spring 48 and threading the flange 492 into the inner surface of the recess 322. In this state, the compression coil spring 48 is compressed between the friction plate 47 and the flange 492.

The head of the torque adjustment screw 49 can be accessed from the open side of the recess 322. Therefore, in a state where the ribbon roll 27 is not attached, the amount of compression of the compression coil spring 48 can be adjusted by changing the amount of threading of the torque adjustment screw 49, thereby adjusting the restoring force of the compression coil spring 48 that presses the friction plate 47 against the slip plate 46.

For example, if the amount of threading of the torque adjustment screw 49 into the mounting portion 32 is increased, the amount of compression of the compression coil spring 48 is also increased, thereby increasing the force with which the friction plate 47 is pressed against the slip plate 46. Conversely, if the amount of threading of the torque adjustment screw 49 into the mounting portion 32 is decreased, the amount of compression of the compression coil spring 48 is decreased, thereby decreasing the pressing force pressing the friction plate 47 against the slip plate 46.

The friction plate 47 can rotate integrally with the slip plate 46 due to the frictional force generated between the two plates, the force being based on the restoring force of the compression coil spring 48. When torque exceeding the frictional force between the slip plate 46 and the friction plate 47 is transmitted to the drive shaft 45, the friction plate 47 slips relative to the slip plate 46, and the transmission path of the drive force is interrupted. The torque threshold that causes the friction plate 47 to slip relative to the slip plate 46 can be adjusted by changing the amount in which the torque adjustment screw 49 is screwed into the mounting portion 32.

The slip plate 46, the friction plate 47, and the compression coil spring 48 function as a drive cut-off unit that interrupts the drive transmission path of the drive transmission mechanism 40 when the supply speed of the ink ribbon 26 exceeds the transport speed of the print medium M by a predetermined threshold due to torque surpassing the aforementioned threshold. The torque adjustment screw 49, which sets the torque threshold, also functions as an adjustment mechanism that changes the slip threshold by varying the pressing force of the friction plate 47 against the slip plate 46.

As shown in FIG. 4, the printer 100 includes a rotary encoder 60 provided midway along the drive transmission mechanism 40. The rotary encoder 60 is provided for both the feed-side drive transmission mechanism 40 and the take-up-side drive transmission mechanism 40. The rotary encoder 60 includes a plurality of detection windows 433 arranged at regular intervals around the entire circumference, passing through the outer periphery of the large-diameter gear 431 of the double gear 43, and also includes a light-emitting unit and a light-receiving unit having optical axes that pass through the plurality of detection windows 433 during rotation of the double gear 43.

As shown in FIG. 6, the control system that controls the operation of the printer 100 described above includes a control unit 70 provided with a CPU (Central Processing Unit). The control unit 70 is coupled to a ROM 71, a RAM 72, a rotary encoder 60, a head driver 73, and a motor driver 74, via a bus and an interface.

The ROM 71 stores programs executed by the printer 100 and various data. The RAM 72 is a working memory used to temporarily store programs and data while the CPU executes various programs.

The take-up-side rotary encoder 60 of the drive transmission mechanism 40 receives light emitted from the light-emitting element and passing through the plurality of detection windows 433 located on the light-receiving element while the DC motor 52 is driven, and outputs a signal corresponding to the amount of light received per unit time. Likewise, the feed-side rotary encoder 60 outputs a signal corresponding to the amount of light received within a unit time.

The head driver 73 is coupled to the thermal head 24. The head driver 73 energizes the plurality of heating elements of the thermal head 24 in response to image signals, and transfers ink from the ink ribbon 26 to the print medium M conveyed at a constant speed, to print an image.

The motor driver 74 is coupled to the stepping motor 75 that rotates the platen roller 23, a DC motor 51 that applies torque to the ribbon roll 25 for feeding unused ink ribbon 26, and a DC motor 52 that applies torque to the ribbon roll 27 for taking up the used ink ribbon 26.

The control unit 70 includes modules such as a detection unit 76 and an adjustment unit 77. The control unit 70 implements the functions of the detection unit 76, adjustment unit 77, etc. by loading a program from the ROM 71 into the RAM 72 and executing the program.

The detection unit 76 estimates the diameter of the take-up ribbon roll 27, based on the output of the take-up rotary encoder 60. At this time, the detection unit 76 calculates, for example, the rotational speed of the mounting portion 32 based on the output of the rotary encoder 60, and also calculates the diameter of the ribbon roll 27 based on the supply speed of the ink ribbon 26 (i.e., the transport speed of the printing medium M) preset by the printer 100. Alternatively, the output of the rotary encoder 60 is referenced in a pre-prepared data table to extract the diameter of the corresponding ribbon roll 27. The detection unit 76 similarly estimates the diameter of the feed-side ribbon roll 25, based on the output of the feed-side rotary encoder 60.

The adjustment unit 77 adjusts the drive voltage applied to the DC motor 52 according to the diameter of the take-up-side ribbon roll 27 detected by the detection unit 76. At this time, the adjustment unit 77 adjusts the drive voltage applied to the DC motor 52 so that the tension of the ink ribbon 26 being taken up by the ribbon roll 27 is maintained constant at all times, regardless of the diameter of the ribbon roll 27. The adjustment unit 77 also adjusts the drive voltage applied to the DC motor 51 according to the diameter of the feed-side ribbon roll 25 so that the tension of the ink ribbon 26 being fed from the ribbon roll 25 is maintained constant at all times.

When an image is printed on a print medium M using the printer 100 of the present embodiment, the stepping motor 75 rotates the platen roller 23 to convey the print medium M along the transport path 22, while the DC motors 51 and 52 simultaneously rotate the ribbon rolls 25 and 27 to supply the ink ribbon 26 to the transport path 22. In this state, the plurality of heating elements of the thermal head 24 are energized to transfer ink from the ink ribbon 26 to the print medium M, thereby printing an image.

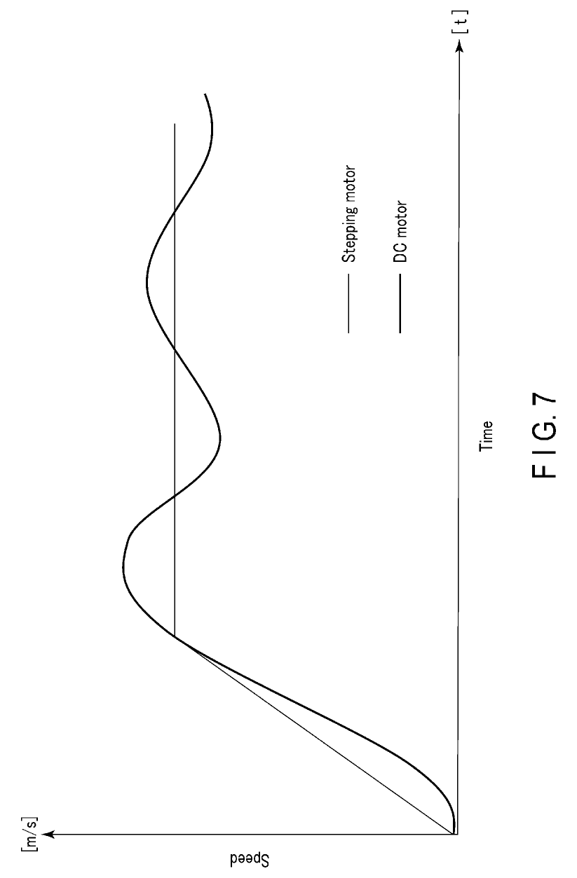

FIG. 7 is a graph showing the drive characteristics of the stepping motor 75 that conveys the print medium M and the DC motor 52 that supplies the ink ribbon 26. The stepping motor 75 quickly stabilizes at a predetermined transport speed after the stationary platen roller 23 begins to rotate, whereas the DC motor 52 requires a longer time to settle at a predetermined supply speed after the stationary ribbon roll 27 begins to rotate.

For this reason, in the printer 100 according to the present embodiment, the current supplied to the DC motor 52 is temporarily increased when the DC motor 52 starts rotating from the stationary state of the ribbon roll 27. The current is then decreased as the rotational speed of the ribbon roll 27 approaches the predetermined supply speed, thereby shortening the startup time of the DC motor 52 to match that of the stepping motor 75 as closely as possible.

If the current flowing through the DC motor 52 is controlled as described above, the rotational speed of the DC motor 52 remains unstable, as shown in FIG. 7, until the rotational speed of the ribbon roll 27 stabilizes at the predetermined supply speed. If such speed fluctuations in the DC motor 52 cause the winding speed of the ink ribbon 26 to become slower than the transport speed of the print medium M, slack may occur in the ink ribbon 26 between the platen roller 23 and the ribbon roll 27, making it difficult to separate the ink ribbon 26 from the print medium M.

In order to prevent such a problem, the current supplied to the DC motor 52 can be set to a large value when the DC motor 52 starts rotating. If this is done, however, a large inertial force acts on the ribbon roll 27 after the rotational speed of the ribbon roll 27 approaches the predetermined supply speed and the current value is reduced. As a result, the rotational speed of the ribbon roll 27 cannot be sufficiently decreased. In such a case, the supply speed of the ink ribbon 26 becomes faster than the transport speed of the print medium M. If the supply speed of the ink ribbon 26 exceeds a predetermined threshold and becomes faster than the transport speed of the print medium M, the print medium M is pulled by the ink ribbon 26 due to the frictional force between the print medium M and the ink ribbon 26, causing the transport speed of the print medium M to increase beyond the normal transport speed. Consequently, the image becomes elongated in the transport direction.

In the present embodiment, to address the problem of poor image quality, a mechanism for interrupting the transmission of a drive force is provided midway through the drive transmission mechanism 40, which transmits the drive force of the DC motor 52 to the ribbon roll 27. The transmission of drive force is interrupted when a torque is applied to the ink ribbon 26, which would cause the transport speed of the print medium M to exceed the predetermined transport speed.

After the transmission of the driving force is interrupted, once the supply speed of the ink ribbon 26 falls below the threshold and the rotational speed of the ribbon roll 27, which is rotating due to inertia, drops to a level that does not pull the print medium M, a frictional force acts between the slip plate 46 and the friction plate 47. This force releases the interruption of the transmission path by the drive transmission mechanism 40.

As described above, in the present embodiment, the startup time of the DC motor 52 is shortened so that the supply speed of the ink ribbon 26 matches the transport speed of the print medium M. If a torque acting during the startup of the DC motor 52 temporarily causes the supply speed of the ink ribbon 26 to exceed the transport speed of the print medium M, the transmission path of the drive force that rotates the ribbon roll 27 is temporarily interrupted. Accordingly, in the present embodiment, the supply speeds of the print medium M and the ink ribbon 26 can be controlled to be the same, at least to the extent that the transport speed of the print medium M passing the thermal head 24 is not excessively accelerated, thereby improving print quality.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a print head disposed adjacent to a transport path;
a transport unit that conveys a print medium along the transport path at a constant speed;
a supply unit that supplies an ink ribbon along the transport path so that the ink ribbon overlaps a side of the print medium facing the print head;
a control unit that controls a supply speed of the ink ribbon supplied by the supply unit so that the ink ribbon is supplied at a speed equal to that of the print medium; and
a drive cut-off unit that interrupts a drive transmission path in the supply unit in a case where the supply speed of the ink ribbon exceeds a predetermined threshold and becomes faster than a transport speed of the print medium.

2. The printer according to claim 1, wherein the drive cut-off unit releases interruption of the drive transmission path when the supply speed of the ink ribbon falls below the predetermined threshold after the drive transmission path is interrupted.

3. The printer according to claim 1, further comprising:
a platen roller that is disposed opposite the print head across the transport path, sandwiches and presses the print medium and the ink ribbon between the print head and the platen roller, and is rotatable in a transport direction of the print medium.

4. The printer according to claim 3, wherein the threshold is a value at which, when the supply speed of the ink ribbon exceeds the threshold, the print medium is pulled by the ink ribbon due to a frictional force between the ink ribbon and the print medium, causing the print medium to be accelerated in the transport direction.

5. The printer according to claim 3, wherein the transport unit includes, in addition to the platen roller, a stepping motor that rotates the platen roller.

6. The printer according to claim 1, wherein the supply unit includes a take-up shaft that takes up a used ink ribbon from which ink has been transferred to the print medium via the print head, and a drive motor that rotates the take-up shaft.

7. The printer according to claim 6, wherein the drive motor is a DC motor.

8. The printer according to claim 7, wherein the drive cut-off unit includes: a slip plate that is rotated by the DC motor; a friction plate that is arranged coaxially with the slip plate, is integrally rotatable with the take-up shaft, and is capable of coming into contact with the slip plate; and an elastic member that presses the friction plate against the slip plate, and the drive cut-off unit causes slippage between the slip plate and the friction plate and thereby interrupts the drive transmission path in a case where a torque large enough to transport the ink ribbon at a supply speed exceeding the threshold acts on the slip plate.

9. The printer according to claim 8, wherein the drive cut-off unit includes an adjustment mechanism that adjusts compression of the elastic member, thereby varying a restoring force with which the elastic member presses the friction plate against the slip plate and changing the threshold.

10. The printer according to claim 9, wherein the elastic member is a compression coil spring.

11. A printer comprising:
a print head disposed adjacent to a transport path;
a transport unit that conveys a print medium along the transport path at a first speed;
a supply unit driven by a drive motor and supplies an ink ribbon at a second speed between the print medium and the print head, along a transport direction of the print medium;
a control unit that controls a voltage applied to the drive motor so that the second speed is equal to the first speed; and
a drive cut-off unit that interrupts a drive transmission path of the drive motor in a case where the second speed exceeds the first speed by a predetermined threshold.

12. The printer according to claim 11, wherein the drive cut-off unit releases interruption of the drive transmission path in a case where the second speed falls below the predetermined threshold after the drive transmission path is interrupted.

13. The printer according to claim 11, further comprising:
a platen roller that is disposed opposite to the print head across the transport path, sandwiches and presses the print medium and the ink ribbon between the print head and the platen roller, and is rotatable in the transport direction of the print medium.

14. The printer according to claim 13, wherein the threshold is a value at which, when the second speed exceeds the threshold, the print medium is pulled by the ink ribbon due to a frictional force between the ink ribbon and the print medium, causing the print medium to be accelerated in the transport direction.

15. The printer according to claim 13, wherein the transport unit includes, in addition to the platen roller, a stepping motor that rotates the platen roller.

16. The printer according to claim 11, wherein the supply unit includes a take-up shaft that takes up a used ink ribbon from which ink has been transferred to the print medium via the print head, in addition to the drive motor that rotates the take-up shaft.

17. The printer according to claim 16, wherein the drive motor is a DC motor.

18. The printer according to claim 17, wherein the drive cut-off unit includes: a slip plate that is rotated by the DC motor; a friction plate that is arranged coaxially with the slip plate and is integrally rotatable with the take-up shaft and that is capable of coming into contact with the slip plate; and an elastic member that presses the friction plate against the slip plate, and when a torque of a magnitude that conveys the ink ribbon at the second speed exceeding the threshold acts on the slip plate, slippage occurs between the slip plate and the friction plate, thereby interrupting the drive transmission path of the DC motor.

19. The printer according to claim 18, wherein the drive cut-off unit includes an adjustment mechanism that adjusts a compression amount of the elastic member to adjust a restoring force of the elastic member that presses the friction plate against the slip plate, thereby varying the threshold.

20. The printer according to claim 19, wherein the elastic member is a compression coil spring.
